(19) United States
(12) Patent Application Publication
(10) Pub. No.: US 2005/0180454 A1
(43) Pub. Date: Aug. 18, 2005

(54) Dual-mode mobile terminal having a mode switching circuit

(76) Inventors: Dong-Il Lee, Seoul (KR); Hyung-Il Lee, Seoul (KR); Min-Kyo Jung, Seoul (KR)

Correspondence Address: MORGAN & FINNEGAN, L.L.P., 3 World Financial Center, New York, NY, 10281-2101, US

(21) Appl. No.: 11/035,791

(22) Filed: Jan. 14, 2005

(30) Foreign Application Priority Data
Jan. 16, 2004 (KR) 2004-3176

(51) Int. Cl. H04J 3/16

(52) U.S. Cl. 370/465

(57) ABSTRACT

A dual-mode mobile terminal is disclosed in which a switching between the modes is performed. The dual-mode mobile terminal of the present invention is implemented with a single CPU, two or more dual-port randon access memories (DPRAMs) and two or more MODEMs along with interface units (IUs) that prevents the occurrence of interference between parts for respective modes when the CPU and the MODEMs communicate with each other via the DPRAMs in a mobile communication terminal that use a single central processing unit and a plurality of modem chips. The IUs perform control operations so that part of signals to be applied to each of the MODEMs is/are applied only when an activation signal for the MODEM is enabled. The IUs may be implemented with logic gates, and the part of signals include an interrupt signal allowing each MODEM to be released from a sleep state.

### BACKGROUND OF THE INVENTION

1. Field of the Invention

The present invention relates, in general, to a dual-mode mobile terminal having a mode switching circuit and mode switching method using the same and, more particularly, to a dual-mode mobile terminal, which performs switching between modes in a manner that prevents the occurrence of interference between parts for respective modes when a central processing unit (CPU) and MODEMs communicate with each other using dual-port random access memories (DPRAMs) in a mobile communication terminal that use a single central processing unit and a plurality of MODEM chips.

2. Description of the Related Art

A mobile terminal capable of being used in both a Code Division Multiple Access (CDMA) network and a Wideband CDMA (WCDMA) network is called a dual-mode mobile terminal. The dual-mode mobile terminal is provided with a Radio Frequency (RF) circuit and a modem for CDMA and an RF circuit and a modem for WCDMA so that the dual-mode mobile terminal can be used in both the CDMA network and the WCDMA network.

A dual-mode mobile terminal controls a plurality of MODEMs using a single Central Processing Unit (CPU). However, when a mobile terminal is used in one mode, a modem for the other mode is generally in a sleep mode or power-down mode. However, when hand-off between modes occurs, the MODEMs of the two modes may be simultaneously activated.

In the meantime, in order to perform communication between a CPU and MODEM chips, Dual-Port Random Access Memory (DPRAM) is used to prevent an instant overflow of data occurring due to the difference in data transfer rate and allow the CPU to communicate with a plurality of chips. An example of this construction is shown in FIG. 1.

A DPRAM has two input/output ports, so that data can be freely written in or read from the DPRAM between chips connected to the two ports. In FIG. 1, a CPU 400 exchanges data with MODEM 601 using DPRAM 501, and exchanges data with MODEM 602 using DPRAM 502. That is, the CPU 400 writes or reads data in or from DPRAM 501 using signal lines 51 connected to one port of DPRAM 501. MODEM 601 writes or reads data in or from DPRAM 501 using signal lines 52 connected to the other port of DPRAM 501. The communication between CPU 400 and MODEM 602 is performed using DPRAM 502 through signal lines 51 and 53 in a similar way to the communication between CPU 400 and MODEM 601.

In the meantime, each of DPRAMs 501, 502 and MODEMs 601, 602 may be connected to a separate power source including Powers 1-4, respectively, to allow CPU 400 to individually control the power. Further, according to circumstances, DPRAMs 501 and 502 may be connected together to a power source having the same level (for example: 2.8V). Further, these chips have terminals that are capable of controlling power-down operations thereof and are connected to control signals PE5, PE6, PE7 and PE8 output from CPU 400, so that the CPU can individually control the power-down operations of the chips such as the DPRAMs and MODEMs.

However, in the case of a chip including Complementary Metal-Oxide Semiconductor (CMOS) or Transistor-Transistor Logic (TTL) devices, the state of the output terminal of the chip may not be defined when the chip is in a power-down state or sleep state. That is, the logic level of the output terminal may be changed between a high or low state in the power-down state or sleep state.

However, in the case of a modem chip, an interrupt terminal is frequently used to allow the modem chip to be released from a sleep state. That is, if a low signal is applied to the interrupt terminal, the modem chip is released from the sleep state and returns to a normal state. Therefore, if the output of DPRAM being in a power-down or sleep state and connected to the interrupt terminal of a modem chip becomes low when any one mode is inactivated, malfunction inevitably causing the modem chip to be activated may occur.

### SUMMARY OF THE INVENTION

Accordingly, the present invention has been made keeping in mind the above problems occurring in the prior art, and an object of the present invention is to provide a dual-mode mobile terminal having a mode switching circuit which is capable of preventing conventional malfunction that may occur when one mode is inactivated in a dual-mode mobile terminal equipped with a single CPU and two modems.

In order to accomplish the above object, the present invention provides a dual-mode mobile terminal comprising dual-port random access memories (DPRAMs) provided between the CPU and the modems, respectively, each DPRAM having a first port connected to a signal bus extended from the CPU and a second port connected to a signal bus extended from a corresponding modem so as to exchange data between the CPU and the modem. Interface units are provided between the DPRAMs and the modems to perform a control operation so that part of signals to be applied to each modem from the corresponding DPRAM are applied to the modem only when an activation signal for the modem is enabled. The interface units may be implemented using logic gates each having a first input terminal connected to the activation signal for the modem, a second input terminal connected to one of the part of signals, and an output terminal connected to a corresponding signal terminal extended from the modem, so that the one of the part of signals is output only when the activation signal for the modem is enabled. In the meantime, the corresponding signal applied through some of the signal lines may include an interrupt signal causing each modem to be released from a sleep state or power-down state.

### BRIEF DESCRIPTION OF THE DRAWINGS

FIG. 1 is a block diagram showing the connections of a CPU with modems in a conventional dual-mode mobile terminal;

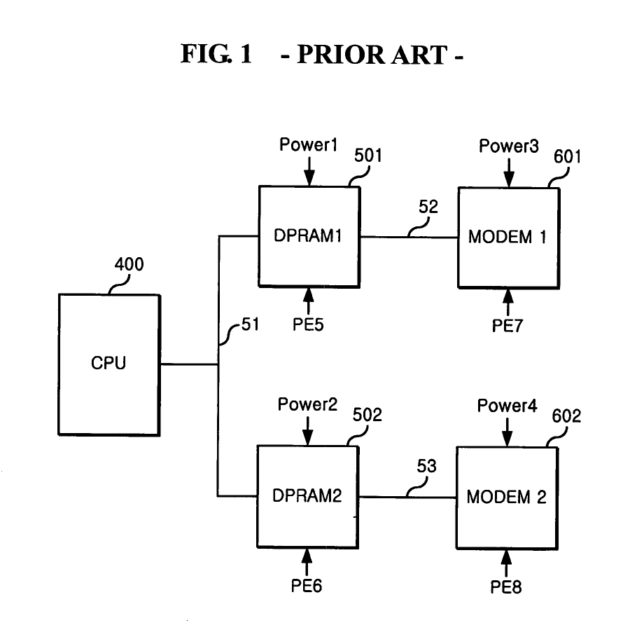

FIG. 2 is a block diagram showing the connections of a CPU with modems in a dual-mode mobile terminal according to the present invention; and

FIG. 3 is a view showing an example of an interface unit between a dual-port RAM and a modem.

### DESCRIPTION OF THE PREFERRED EMBODIMENTS

Hereinafter, embodiments of the present invention will be described in detail with reference to the attached drawings.

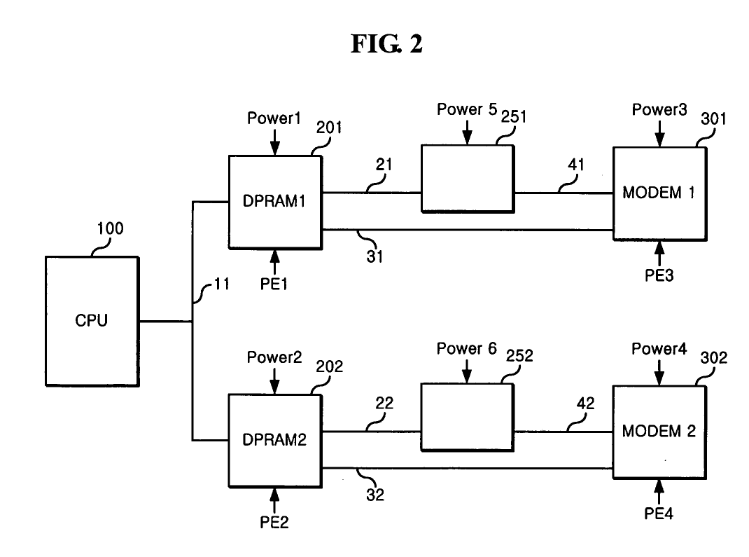

FIG. 2 is a block diagram showing the connection of CPU 100 with DPRAMs 201, 202, and MODEMs 301, 302 in a dual-mode mobile terminal according to the present invention. DPRAM 201 and MODEM 301 may be used in a first mode (e.g., CDMA mode) and DPRAM 202 and MODEM302 may be used in a second mode (e.g., WCDMA mode) under the control of the CPU. The CPU may select either one of the first and second modes based on a received control signal. A mode switching circuit may be used to switch between the first and second modes.

In the present invention, an Interface Unit (IU) is provided between a DPRAM chip and a MODEM chip. Specifically, IU 251 is provided between a first DPRAM 201 and a first MODEM 301 via signal lines 21 and 41. IU 252 is provided between a second DPRAM 202 and a second MODEM 302 via signal lines 22 and 42. Additionally, each pair of DPRAM 201 and MODEM 301, and DPRAM 202 and MODEM 302 is connected directly via signal lines 31 and 32, respectively, as shown in FIG. 2. In an embodiment, each of signal lines 11, 31, 32, 51, 52 and 53 may be a signal bus having multiple signal lines and each of signal lines 21, 22, 41 and 42 may be a portion of the signal bus (e.g., a single signal line).

Output ports of DPRAMs 201, 202 may not be in a definite level when the DPRAMs are in a power-down or sleep state. For example, they may be put in a high impedance state when the DPRAMs are in a power-down or sleep state, which means that they become very sensitive to noise causing unwanted actions to respective MODEMs 301, 302. Each of IUs 251, 252 of FIG. 2 is configured to output stable signals to respective MODEMs 301, 302 in this case. For example, assuming that MODEMs 301, 302 are released from a sleep state when low signals are applied to the interrupt terminals of the respective modems, each of IUs 251, 252 ensures low signals to be applied to the interrupt terminals of the respective modems only when the modems must be activated (i.e., must be released from the sleep state). Modems are to be activated, for example, where activation signals for the modems are enabled. The CPU may generate the activation signal for the modems to be activated. Alternatively, power enable signals PE3 and PE4 may be used as the activation signals.

Signal lines connected through IUs 251, 252 include signal lines for allowing MODEMs 301, 302 to be released from a sleep or power-down mode, for example, interrupt signal lines. Also, it is preferable that those signal lines that do not have a definite output level when one of the DPRAMs is in a power-down or sleep state, and may influence the operation of the modem chips due to the undefined output level be connected to the modem chips through the IUs.

In the meantime, Powers 5, 6 supplied to IUs 251, 252 may be separate from the Powers 1-4 supplied to DPRAMs 201, 202 and MODEMs 301, 302. That is, even when the power is not supplied to DPRAMs 201, 202 or MODEMs 301, 302, the IUs 251, 252 may be operated independently using a separate power. For example, the IUs may be operated using the same power as that supplied to CPU 100. However, when the power is constantly supplied to the MODEMs and the DPRAMs, and the power supplied to these chips is controlled through separate power-down terminals, the same power as that used in these chips may be used.

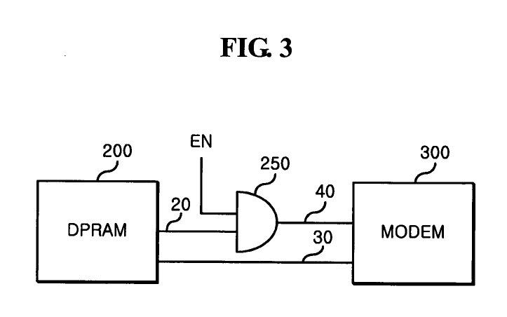

Next, an embodiment of IUs 251, 252 is described with reference to FIG. 3.

In this embodiment, an AND gate 250 is used as the IU. This embodiment shows that MODEM 300 is activated when a signal from a signal line 40 applied to MODEM 300 is high. One of the input terminals of AND gate 250 is connected to a signal line 20 extended from DPRAM 200, and the other thereof is connected to an activation signal EN for MODEM 300. The output signal of AND gate 250 is high only when both of the input terminals (i.e., inputs from signal lines EN and 20) are high, according to the characteristics of AND gate 250. Accordingly, when the activation signal EN for MODEM 300 is disabled (i.e., low), the output signal of AND gate 250 is low regardless of the logic state of the signal line 20 extended from DPRAM 200. Therefore, since the signal from signal line 40 applied to MODEM 300 is always maintained low when the activation signal EN for MODEM 300 is disabled, malfunction causing MODEM 300 to be influenced by variation in an output signal of DPRAM 200 in the power-down or sleep state does not occur. In the meantime, the signal line 30, without having an influence on MODEM 300, is directly connected from DPRAM 200 to MODEM 300.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. For example, FIG. 3 shows an example of an interface unit using an AND gate. However, another type of gate, such as an OR gate, may be used according to the type of signal line of a MODEM. It is also possible to use a means other than a logic gate.

As described above, the present invention provides a dual-mode mobile terminal having a mode switching circuit, in which signal lines, influencing MODEMs when one of the modes is inactivated, are connected to the MODEMs through interface units in the dual-mode mobile terminal equipped with a single CPU and two modems, thus preventing malfunction from occurring due to variation in signal lines when the mode is inactivated.

1. A dual-mode mobile terminal comprising:
a central processing unit (CPU) capable of processing signals for the dual-mode mobile terminal;
a MODEM capable of modulating and demodulating the signals;
a dual-port random access memory (DPRAM) provided between the CPU and the MODEM, wherein the DPRAM has a first port configured to connect to the CPU and a second port configured to connect to the MODEM so as to exchange data between the CPU and the MODEM; and
an interface unit, provided between the DPRAM and the MODEM, wherein the interface unit has a first port configured to connect to the DPRAM and a second port configured to connect to the MODEM, and wherein the interface unit performs a control operation in which a control signal from the DPRAM is applied to the MODEM only when an activation signal for the MODEM is enabled.

2. The dual-mode mobile terminal according to claim 1, wherein the MODEM is designed to be released from a sleep state when an interrupt terminal is applied with a low state.

3. The dual-mode mobile terminal according to claim 1, wherein connection between the CPU and the DPRAM is via a signal bus, and each of connections between the DPRAM and the interface unit, and between the interface unit and the CPU is via a portion of the signal bus.

4. The dual-mode mobile terminal according to claim 1, wherein the DPRAM and the MODEM also have an independent signal line that connects the DPRAM and MODEM directly bypassing the interface unit.

5. The dual-mode mobile terminal according to claim 1, wherein the interface unit is a logic gate having a first input terminal connected to an activation signal for the MODEM, a second input terminal connected to one of the part of signals, and an output terminal connected to a corresponding signal terminal extended from the MODEM.

6. The dual-mode mobile terminal according to claim 3, wherein the logic gate is an AND gate.

7. The dual-mode mobile terminal according to claim 1, wherein the interface unit is provided with a separate power source from the power supplied to the DPRAM or the MODEM.

8. A dual-mode mobile terminal comprising:
a single central processing unit (CPU) capable of processing signals for the dual-mode mobile terminal;
at least two MODEMs capable of modulating and demodulating the signals;
at least two dual-port random access memories (DPRAMs) each provided between the CPU and a corresponding one of the at least two MODEMs, wherein each of the DPRAMs has a first port configured to connect to the CPU and a second port configured to connect to a corresponding one of the MODEMs so as to exchange data between the CPU and the MODEMs; and
at least two interface units, each provided between a corresponding one of the DPRAMs and a corresponding one of the MODEMs, wherein each of the interface units has a first port configured to connect to corresponding one of the at least two DPRAMs and a second port configured to connect to corresponding one of the at least two MODEMs, and
wherein the dual-mode mobile terminal is capable of operating in either one of a first mode or a second mode where one of a corresponding interface units performs a control operation in which a control signal from a corresponding one of the DPRAMs is applied to a corresponding one of the MODEMs only when an activation signal for the corresponding one of the MODEMs is enabled.

9. The dual-mode mobile terminal according to claim 8, wherein each of the MODEMs is designed to be released from a sleep state when an interrupt terminal is applied with a low state.

10. The dual-mode mobile terminal according to claim 8, wherein one of the DPRAMs and one of the MODEMs are directly connected with independent signal lines bypassing corresponding one of the at least two interface units.

11. The dual-mode mobile terminal according to claim 8, wherein one of the at least two interface units is a logic gate having a first input terminal connected to an activation signal for a corresponding one of the MODEMs, a second input terminal connected to one of the part of signals, and an output terminal of the logic gate is connected to a corresponding signal terminal extended from a corresponding one of the MODEMs.

12. The dual-mode mobile terminal according to claim 11, wherein the logic gate is an AND gate.

13. The dual-mode mobile terminal according to claim 8, wherein one of the at least two interface units is provided with a separate power source from the power supplied to the DPRAMs or the MODEMs.

14. A dual-mode mobile terminal comprising:
a central processing unit (CPU) capable of processing signals for the dual-mode mobile terminal;
a MODEM capable of modulating and demodulating the signals;
a dual-port random access memory (DPRAM) provided between the CPU and the MODEM, wherein the DPRAM has a first port configured to connect to the CPU and a second port configured to connect to the MODEM so as to exchange data between the CPU and the MODEM; and
means for interfacing provided between the DPRAM and the MODEM, wherein said means for interfacing has a first port configured to connect to the DPRAM and a second port configured to connect to the MODEM, and wherein the interface unit performs a control operation in such a way that a control signal from the DPRAM is applied to the MODEM only when an activation signal for the MODEM is enabled.

15. The dual-mode mobile terminal according to claim 14, wherein the MODEM is designed to be released from a sleep state when an interrupt terminal is applied with a low state.

16. The dual-mode mobile terminal according to claim 14, wherein connection between the CPU and the DPRAM is via a signal bus, and each of connections between the DPRAM and the means for interfacing, and between the means for interfacing and the CPU is via a portion of the signal bus.

17. The dual-mode mobile terminal according to claim 14, wherein the DPRAM and the MODEM are directly connected with independent signal lines bypassing the means for interfacing.

18. The dual-mode mobile terminal according to claim 14, wherein the means for interfacing is a logic gate having a first input terminal connected to an activation signal for the MODEM, a second input terminal connected to one of the part of signals, and an output terminal connected to a corresponding signal terminal extended from the MODEM.

19. The dual-mode mobile terminal according to claim 18, wherein the logic gate is an AND gate.

20. The dual-mode mobile terminal according to claim 14, wherein the means for interfacing is provided with a separate power source from the power supplied to the DPRAM or the MODEM.
